(19) United States
(12) Patent Application Publication
(10) Pub. No.: US 2013/0037292 A1
(43) Pub. Date: Feb. 14, 2013

(54) REVERSING ACTUATING MODULE FOR A RECIPROCATING PNEUMATIC TOOL

(71) Applicant: Jui-Lung CHIU, Taichung City (TW)

(72) Inventor: Jui-Lung CHIU, Taichung City (TW)

(73) Assignee: RIYAN PNEUMATIC CO., LTD., Taichung City (TW)

(21) Appl. No.: 13/208,868

(22) Filed: Aug. 12, 2011

(51) Int. Cl. B23B 45/04

(52) U.S. Cl. 173/169

(57) ABSTRACT

A structure of a reversing actuating module of reciprocating pneumatic tools adopts an adaptation between the stage-shaped reversing block and the stage-shaped receiving groove. The bottom end of the air inlet flow path configured in the center of the air pressure inlet seat is not connected to the stage-shaped receiving groove through a straight hole, but a twisted hole formed through the inclined hole configured in the air pressure inlet seat to connect the air inlet flow path alternatively. Further, the diameter of the lower end of the inclined hole is partially enlarged so that the auxiliary ventilating part is corresponded to the area of expanding groove of the stage-shaped receiving groove. The structure can omit the configuration of a spacing ring component, while maintaining the function of reversing actuation. Therefore, the present invention can help to reduce production and processing cost, assembly time, and defect rate.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a reciprocating pneumatic tool, and more particularly to an innovative structure which simplifies the structure of the actuating module while maintaining the function of reversing actuation.

2. Description of Related Art Including Information Disclosed Under 37 CFR 1.97 and 37 CFR 1.98.

Depending on the different types of the tool end, a reciprocating pneumatic tool can have different functions, for instance, pneumatic saw, pneumatic hammer, pneumatic cutter etc. Hence, the reciprocating pneumatic tool disclosed in the present invention shall cover all such types. The actuating principle of a reciprocating pneumatic tool is as follows: pneumatic supply is guided into the tool, a control valve is used to control the open and close of the air pressure, and an actuating module is used to automatically guide the reversing actuation of the air pressure, so that the piston rod together with the tool end (saw, hammer etc) will have reciprocating movement.

In the structure of a reciprocating pneumatic tool, the number of overall components will have a direct influence on the cost and efficiency of production and assembly, and the defect rate will relatively increase when more components are used. Hence, achieving the same function with minimum components has always been an important technical issue in product development and design in the related industry.

A prior-art structure design of a reciprocating pneumatic tool similar to the present invention is disclosed in Taiwan Patent Publication No. 201041700 “Cylinder and Reversing Function Integration Module of a Reciprocating Pneumatic Tool”. This prior-art mainly discloses a cylinder and reversing function integration module comprising a cylinder body, a reversing actuating groove, a reversing brake block, and a spacing ring. The inside end of the cylinder body is configured with a reversing actuating groove so as to integrate the cylinder and the main structure of the airflow reversing function to minimize number of components and reduce cost of production and assembly. However, although this prior-art patent has said advantage compared to more traditional structure designs, the present inventor finds after deliberation that some partial components can still be simplified while maintaining the same function.

Thus, to overcome the aforementioned problems of the prior art, it would be an advancement if the art to provide an improved structure that can significantly improve the efficacy.

Therefore, the inventor has provided the present invention of practicability after deliberate design and evaluation based on years of experience in the production, development and design of related products.

### BRIEF SUMMARY OF THE INVENTION

The “structure of reversing actuating module of reciprocating pneumatic tools” disclosed in the present invention mainly adopts an adaptation between the stage-shaped reversing block and the stage-shaped receiving groove. The bottom end of the air inlet flow path configured in the center of the air pressure inlet seat is not connected to the stage-shaped receiving groove through a straight hole, but a twisted hole formed through the inclined hole configured in the air pressure inlet seat to connect the air inlet flow path alternatively. Further, the diameter of the lower end of the inclined hole is partially enlarged so that the auxiliary ventilating part is corresponded to the area of expanding groove of the stage-shaped receiving groove. Through such an innovative flow path, compared to the prior-art structure disclosed in Taiwan Patent Publication No. 201041700, the present invention can omit the configuration of a spacing ring component, while maintaining the function of reversing actuation. Therefore, the present invention can help to reduce production and processing cost, assembly time, and defect rate. To summarize, the present invention has practical advancement and industrial application value.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 is an assembled perspective view of the reciprocating pneumatic tool of the present invention.

FIG. 2 is an exploded perspective view of the reversing actuating module of the present invention.

FIG. 3 is an assembled sectional view of the reciprocating pneumatic tool of the present invention.

FIG. 4 is an exploded sectional view of the reversing actuating module of the present invention.

FIG. 5 is a first schematic view of the air inlet actuation state of the present invention.

FIG. 6 is a second schematic view of the air inlet actuation state of the present invention.

FIG. 7 is a sectional view along line B-B′ of FIG. 6.

### DETAILED DESCRIPTION OF THE INVENTION

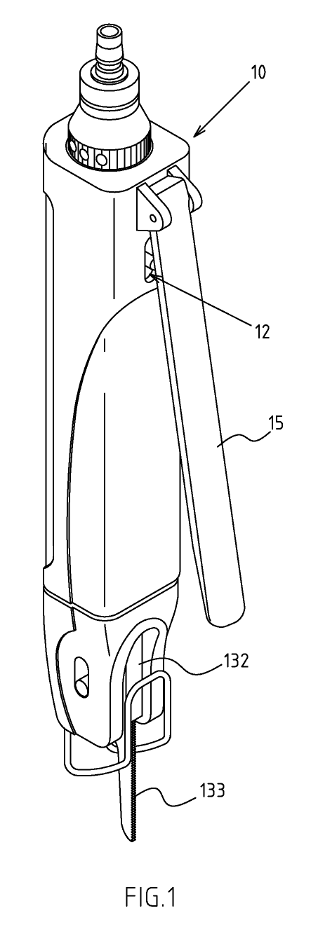

FIGS. 1, 2, 3 and 4 show a preferred embodiment of the reversing actuating module structure of a reciprocating pneumatic tool disclosed in the present invention. However, such an embodiment is for description purpose only and shall not restrict the claims in the patent application. Said reversing actuating module A is configured between the air supply end 121 of the air pressure on/off control module 12 configured inside the receiving groove 11 of the reciprocating pneumatic tool 10 and the movement guide cylinder 14 of the piston rod 13. The piston rod 13 has a piston part 131 and a tool attaching part 132. The tool attaching part 132 can be attached with an acting tool 133 (for instance, a saw blade as disclosed in the embodiment).

The reversing actuating module A comprises an air pressure inlet seat 20, having an air inlet end 21 connected to the air supply end 121 of the air pressure on/off control module 12, and the center of the air pressure inlet seat 20 is configured with an air inlet flow path 22, and the upper end of the air inlet flow path 22 goes out of the air inlet end 21.

A cylinder body 30 is attached to the lower end of the air pressure inlet seat 20. The cylinder body 30 is a hollow cylinder and is formed with a top end 31, a bottom end 32 and an inside cylinder 33, wherein the cylinder 33 is to receive the piston part 131 of the piston rod 13. The cylinder body 30 is configured with an air exhaust part 34 on its side wall, and the top end 31 of the cylinder body 30 is configured with a stage-shaped receiving groove 35. The stage-shaped receiving groove 35 includes an expanding groove 351 and reducing groove 352 respectively configured on the upper and lower side. The bottom end of the reducing groove 352 has a reducing through hole 36 connecting the cylinder 33. The top end 31 of the cylinder body 30 is configured on one side with an air inlet guide hole 37 connecting the reducing groove 352 of the stage-shaped receiving groove 35. On a spaced place of the side of the cylinder 33, a piston backstepping flow channel 38 is configured. The top end of the piston backstepping flow channel 38 is configured with a side guide groove 381 connecting to the expanding groove 351 of the stage-shaped receiving groove 35. The lower end of the piston backstepping flow channel 38 is connected to the side of the lower end of the cylinder 33.

A stage-shaped reversing block 40 is housed in the stage-shaped receiving groove 35 of the cylinder body 30 and can move up and down. The stage-shaped reversing block 40 comprises an upper end surface 43, a large diameter part 41 and a small diameter part 42 configured on the upper and lower side, and a pushed ring 44 formed between the large and small diameter parts 41, 42.

Wherein, the large diameter part 41 is fitted into the expanding groove 351 of the stage-shaped receiving groove 35, while the small diameter part 42 is fitted into the reducing groove 352 of the stage-shaped receiving groove 35.

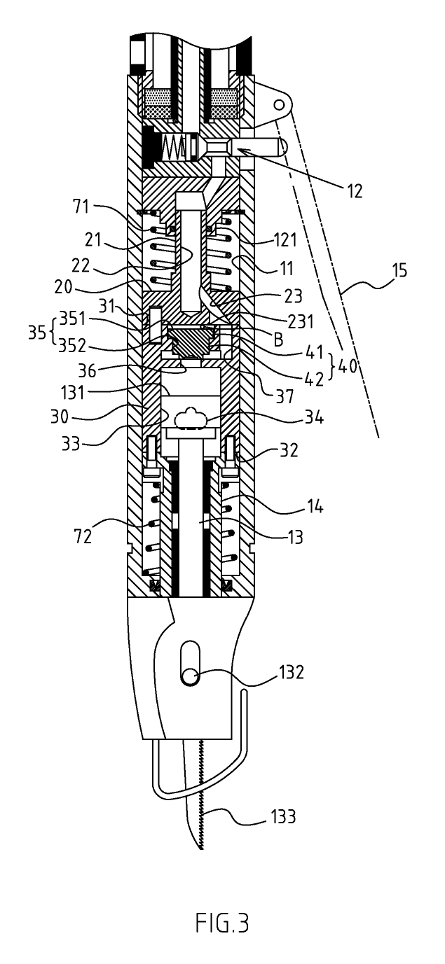

An air pressure space (as marked by “B” in FIG. 3) is formed when the stage-shaped reversing block 40 is going down, and its upper end surface 43 is lower than the top end 31 of the cylinder body 30. The air pressure space is connected to the side guide groove 381.

Further, the bottom end of air inlet flow path 22 configured in the center of the air pressure inlet seat 20 is not connected to the stage-shaped receiving groove 35 configured on the top end 31 of the cylinder body 30 through a direct through hole. Inside the air pressure inlet seat 20, an inclined hole 23 is configured, so that the upper end of the inclined hole 23 and the bottom end of the air inlet flow path 22 is connected through a twisted hole, and the lower end of the inclined hole 23 is aligned to the upper end of the air inlet guide hole 37 configured on the side of top end 31 of the cylinder body 30.

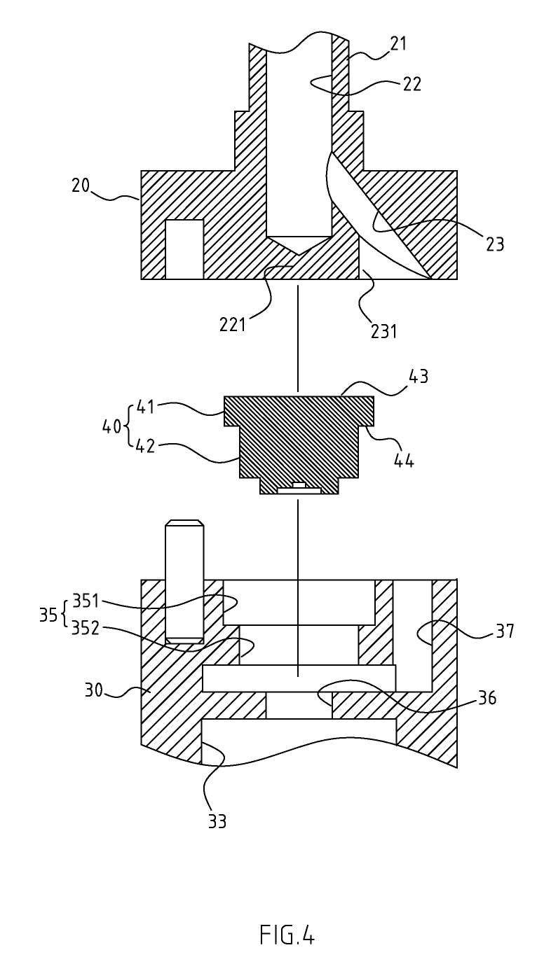

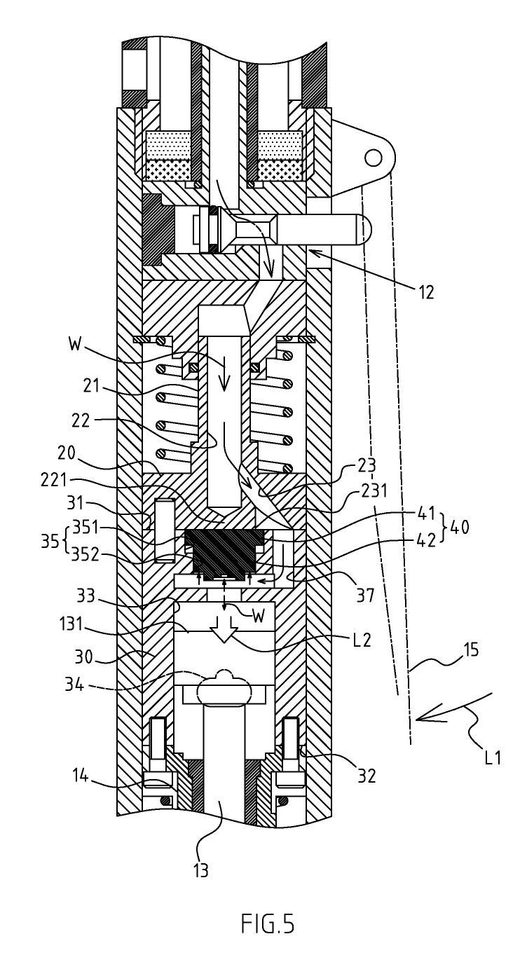

A sealed bottom end edge 221 is formed in the center of the bottom end of the air pressure inlet seat 20 (see detail in FIG. 4), to seal the bottom end of the air inlet flow path 22 configured on the air pressure inlet seat 20 and form a non-straight through hole. When the stage-shaped reversing block 40 is going up (as shown in FIG. 5), it can be directly blocked and limited by the sealed bottom end edge 221.

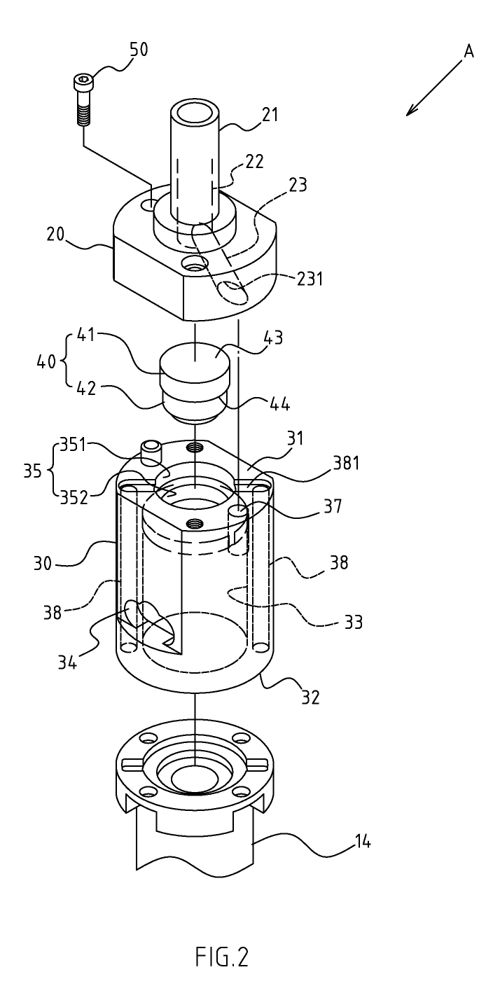

An auxiliary ventilating part 231 is formed through partial enlargement of diameter on one side of the bottom end of the inclined hole 23. Said auxiliary ventilating part 231 must connect and correspond to the area of the expanding groove 351 of the stage-shaped receiving groove 35 configured on the cylinder body 30. The sectional area of the airflow channel between the auxiliary ventilating part 231 and the expanding groove 351 shall be smaller than the sectional area of the airflow channel between the inclined hole and the air inlet guide hole.

Wherein, multiple bolts 50 (only marked in FIG. 2) can be used between the air pressure inlet seat 20 and the cylinder body 30 for fixing.

Based on the structure set forth above, the actuation condition of the present invention is described as follow:

Referring to FIG. 5, to actuate the reciprocating pneumatic tool 10, push the control switch 15 (as marked by Arrow L1) to open the air flow path of the air pressure on/off control module 12, and the air pressure W will pass the air supply end 121 and air inlet end 21 of the air pressure on/off control module 12 and enter the air pressure inlet seat 20. Then, through the overall air flow path design inside the reversing actuating module A, the piston part 131, piston rod 13 together with the acting tool 133 will be actuated to reciprocate up and down very quickly. The air flow path actuation state is described in detail based on the drawings.

Firstly, referring to FIG. 5, when the air pressure W is guided by the air pressure inlet seat 20 into the reversing actuating module A, it will go through the air inlet flow path 22 and inclined hole 23 into the air inlet guide hole 37 configured on the side of the top end 31 of the cylinder body 30 (note: as the sectional area of the air flow path between the auxiliary ventilating part 231 on one side of the bottom end of the inclined hole 23 and the expanding groove 351 is small, the air flow will firstly be guided into the air inlet guide hole 37), and further into the reducing groove 352 of the stage-shaped receiving groove 35. At this time, on one hand, the air pressure W will lift the stage-shaped reversing block 40, so that the upper end surface 43 of the stage-shaped reversing block 40 will be on the same level as the top end 31 of the cylinder body 30 and block the side guide groove 381 (marked in FIG. 2), and on the other hand, the air pressure W will go downside through the through hole 36 and into the cylinder 33 of the cylinder body 30, and push the piston part 131 downside (as marked by Arrow L2).

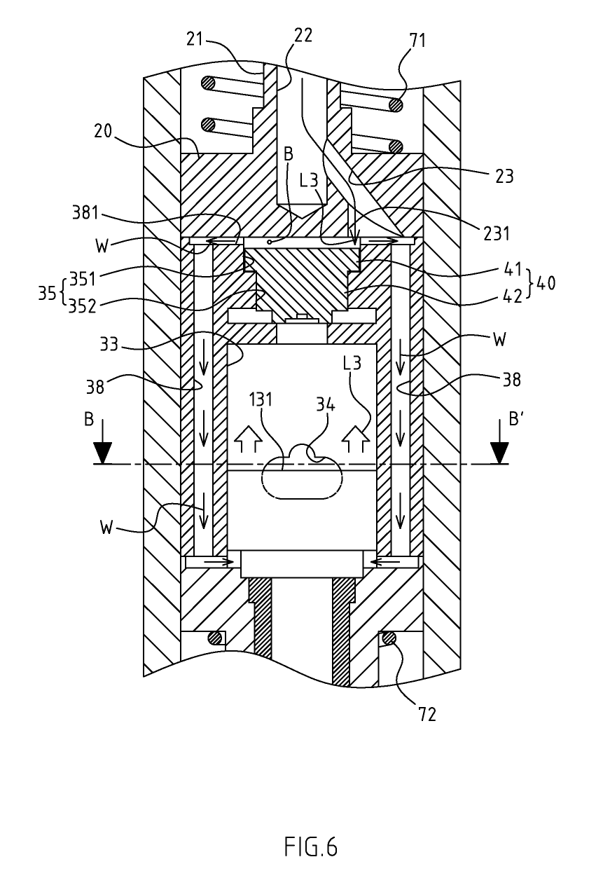

Further, as shown in FIG. 6, when the piston part 131 is pushed downside till the height of the top end of the piston part 131 is lower than the air exhaust part 34 configured on the side of the cylinder body 30, the pressure inside the cylinder 23 will be released through this air exhaust part 34, and at this time, the stage-shaped reversing block 40 originally lifted by the air pressure will go down as the support gets insufficient, until the upper end surface 43 is lower than the top end 31 of the cylinder body 30 and form an air pressure space connecting the side guide groove 381 (as marked by “B” in FIG. 6). In this state, the air pressure W guided in through the inclined hole 23 will be guided in order through the auxiliary ventilating part 231, side guide groove 381, and piston backstepping flow channel 38 into the lower space of the cylinder 33, and push the piston part 131 upward (marked by Arrow L3). And when the piston part 131 goes up until it is higher than the air exhaust part 34 configured on the side of the cylinder body 30, the pressure release inside the cylinder 23 will stop, the flow of air pressure returns to the state shown in FIG. 5, and the reversing action is realized.

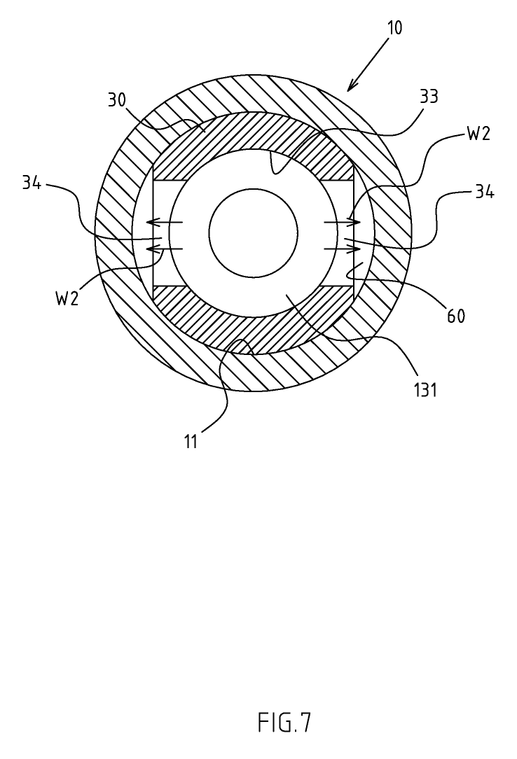

Further, referring to FIG. 7, the sectioning location of this drawing is at the height of the air exhaust part 34 of the cylinder body 30. Regarding the exhaust path during the actuation, when the air pressure inside the cylinder 33 starts to release through the air exhaust part 34, the exhaust air flow W2 will go through the air exhaust part 34 to an exhaust passage 60 preset outside the cylinder body 30, and then go out through the exhaust passage 60. Such a design of exhaust space is known prior art and is not detailed herein.

Wherein, the movement guide cylinder 14 of the piston rod 13 and the bottom end of the cylinder body 30 can be assembled or formed as an integral. The design of this part is not limited.

Referring to FIG. 3, a damping component can be configured inside the receiving groove 11 of the reciprocating pneumatic tool. The damping component can comprise a middle-located buffer 71 (can be a helical spring) configured between the air inlet end 21 of the air pressure inlet seat 20 and the air supply end 121 of the air pressure on/off control module 12, and a front-located buffer 72 (can be a helical spring) configured between the movement guide cylinder 14 of the piston rod 13 and one end wall of the receiving groove 11.

The present invention differs from the prior-art mainly in that the reversing actuating module adopts an adaptation between the stage-shaped reversing block 40 and the stage-shaped receiving groove 35, and that the bottom end of the air inlet flow path 22 configured in the center of the air pressure inlet seat 20 is not connected to the stage-shaped receiving groove 35 through a straight hole, but a twisted hole formed through the inclined hole 23 configured in the air pressure inlet seat 20 to connect the air inlet flow path 22 alternatively. Further, the diameter of the lower end of the inclined hole 23 is partially enlarged so that the auxiliary ventilating part 231 is corresponded to the area of the expanding groove 351 of the stage-shaped receiving groove 35. Through such an innovative flow path design, the present invention can omit the configuration of a spacing ring component adopted in the prior-art set forth above, but still realize the functional purpose of guiding the air reversion and driving the piston. Hence, the present invention has the advantage and advancement of component simplification.

1. A reversing actuating module structure of reciprocating pneumatic tools, attached between the air supply end of the air pressure on/off control module configured inside the receiving groove of the reciprocating pneumatic tool and the movement guide cylinder of the piston rod, which has a piston part and a tool attaching part; the reversing actuating module comprises:
an air pressure inlet seat, having an air inlet end connected to the air supply end of the air pressure on/off control module, and the center of the air pressure inlet seat is configured with an air inlet flow path, and the upper end of the air inlet flow path goes out of the air inlet end;
a cylinder body, attached to the lower end of the air pressure inlet seat; the cylinder body is a hollow cylinder and is formed with a top end, a bottom end and an inside cylinder, wherein the cylinder is to receive the piston part of the piston rod; the cylinder body is configured with an air exhaust part on its side wall, and the top end of the cylinder body is configured with a stage-shaped receiving groove; the stage-shaped receiving groove includes an expanding groove and reducing groove respectively configured on the upper and lower side; the bottom end of the reducing groove has a reducing through hole connecting the cylinder; the top end of the cylinder body is configured on one side with an air inlet guide hole connecting the reducing groove of the stage-shaped receiving groove; on a spaced place of the side of the cylinder, a piston backstepping flow channel is configured; the top end of the piston backstepping flow channel is configured with a side guide groove connecting to the expanding groove of the stage-shaped receiving groove; the lower end of the piston backstepping flow channel is connected to the side of the lower end of the cylinder;
a stage-shaped reversing block, housed in the stage-shaped receiving groove of the cylinder body and can move up and down; the stage-shaped reversing block comprises an upper end surface, a large diameter part, and a small diameter part configured on the upper and lower side, and a pushed ring formed between the large and small diameter parts; wherein, the large diameter part is fitted into the expanding groove of the stage-shaped receiving groove, while the small diameter part is fitted into the reducing groove of the stage-shaped receiving groove;
an air pressure space, formed when the stage-shaped reversing block is going down, and its upper end surface is lower than the top end of the cylinder body; the air pressure space is connected to the side guide groove;
further, the bottom end of the air inlet flow path configured in the center of the air pressure inlet seat is not connected to the stage-shaped receiving groove configured on the top end of the cylinder body through a direct through hole; inside the air pressure inlet seat, an inclined hole is configured, so that the upper end of the inclined hole and the bottom end of the air inlet flow path is connected through a twisted hole, and the lower end of the inclined hole is aligned to the upper end of the air inlet guide hole configured on the side of top end of the cylinder body;
a sealed bottom end edge, formed in the center of the bottom end of the air pressure inlet seat, to seal the bottom end of the air inlet flow path configured on the air pressure inlet seat and form a non-straight through hole; when the stage-shaped reversing block is going up, it can be directly blocked and limited by the sealed bottom end edge;
an auxiliary ventilating part, formed through partial enlargement of diameter on one side of the bottom end of the inclined hole; said auxiliary ventilating part must connect and correspond to the area of the expanding groove of the stage-shaped receiving groove configured on the cylinder body; the sectional area of the airflow channel between the auxiliary ventilating part and the expanding groove shall be smaller than the sectional area of the airflow channel between the inclined hole and the air inlet guide hole.

2. The structure defined in claim 1, wherein multiple bolts are used between the air pressure inlet seat and the cylinder body for fixing and making it a whole body.

3. The structure defined in claim 1, wherein the movement guide cylinder of the piston rod and the bottom end of the cylinder body are assembled or formed as an integral.

4. The structure defined in claim 1, wherein a damping component is configured inside the receiving groove of the reciprocating pneumatic tool; the damping component comprises a middle-located buffer configured between the air inlet end of the air pressure inlet seat and the air supply end of the air pressure on/off control module, and a front-located buffer configured between the movement guide cylinder of the piston rod and one end wall of the receiving groove.
